(19) United States
(12) Patent Application Publication
(10) Pub. No.: US 2026/0214041 A1
(43) Pub. Date: Jul. 23, 2026

(54) TIMESTAMPING DEVICE AND METHOD

(71) Applicant: Orange, Issy-les-Moulineaux (FR)

(72) Inventors: Nicolas Bihannic, Chatillon (FR); Daniel Philip Venmani, Chatillon (FR); Fabrice Deletre, Chatillon (FR)

(21) Appl. No.: 19/138,997

(22) PCT Filed: Dec. 12, 2023
(86) PCT No.: PCT/EP2023/085378

§ 371 Date: Jun. 13, 2025

(30) Foreign Application Priority Data
Dec. 15, 2022 (FR) 2213449

(51) Int. Cl. H04L 43/106; H04L 43/0852

(52) U.S. Cl. CPC H04L 43/106; H04L 43/0852

(57) ABSTRACT

A timestamping device and method is described. The device includes a first interface with a first network for communicating with a first terminal and a second interface with a second network for communicating with one or more units of the second network. The device is configured to update an internal clock of the device using reference time information from a unit of the second network, receive a first message from the first terminal unit, to be transmitted to a second device through the second network, timestamp the first message using an internal clock, based on a time of receiving the first message, transmit the first message to the second network, and receive additional timestamp information based on an internal clock of the second device relating to a time of receiving the first message in the second device.

### TECHNICAL FIELD

The invention relates to a timestamping method for timestamping messages in a network.

### PRIOR ART

The use of the telecommunications networks by industrialists imposes increasingly high performance requirements on the networks to meet the constraints and the requirements of sensitive applications, in particular the applications relating to energy distribution and production, but not exclusively. The introduction of the cellular networks in the industrial processes, replacing the wired networks, requires the network operators to monitor more closely the reliability and time of transfer of the data relating to these processes in the network, as the transfer time in the wired networks being generally more predictable than in the cellular networks.

A challenge for the telecommunications operators is not only to meet the expected performance on the technical chain for which they are responsible, but also to be able to provide proof of the achievement of this performance.

The present disclosure helps meeting this need.

### DISCLOSURE OF THE INVENTION

For this purpose, a communication device is proposed comprising:
a first interface with a first network to communicate with a first terminal equipment,
a second interface with a second network different from the first network to communicate with one or several equipment of said second network,
one or several processors configured together or separately to:
update an internal clock of the device from a first reference time information obtained from one or several equipment of said second network,
receive at least one first message from said first terminal equipment through said first interface intended to be transmitted to one or several second devices through the second network,
timestamp said at least first message using at least one first timestamp information obtained from said one internal clock, said first timestamp information relating to a date of receipt of said first message in the device, and
transmit said at least first message through said second interface to said second network,
receive at least one second timestamp information determined from an internal clock of one of said second devices obtained from a second reference time information, said second timestamp information relating to a date of receipt of said first message in one of said second devices.

Thus, the present disclosure advantageously makes it possible to have, in an access gateway, timestamp information relating to messages transmitted by a terminal to another terminal through this access gateway via the second network. This timestamp information allows for example the gateway or a terminal connected to the gateway to monitor the transfer times in the second network or the chronology of the transferred messages. This advantageously allows the gateway to provide a timestamping service to a terminal connected to the gateway that uses the services of a communication network to transfer messages. When the messages must be routed on the second network according to a maximum latency time determined and guaranteed by the gateway, it is then possible to verify that this guarantee is met, this verification being able to be made by the gateway or by the terminal from the timestamp information. Thus, the present disclosure makes it possible to verify the latency time in the second network, for each message, and possibly to raise an alarm to the network operator when the latency time is greater than a latency time that the operator had guaranteed to the terminal or to the service subscribed to by the terminal.

According to some embodiments, the device is configured to determine a transfer time in said second network from said first timestamp information and said second timestamp information.

Advantageously, the timestamp information make it possible to determine a transfer time in the second network, for example cellular network, to which the gateway is connected. Thus, it is possible to have in the gateway, for each message or for some messages, the transfer time in the network. This information relating to the transfer time can advantageously be compared to a guaranteed transfer time (or guaranteed latency time) by the operator of the second network to the first terminal and if this measured transfer time is greater, it is possible to raise an alarm to the operator and/or to the first terminal or service subscribed to by this first terminal. Upon receipt of this alarm, it may be envisaged to modify or intervene on one or several network equipment to guarantee again the operation of this subscribed service.

According to some embodiments, the device is configured to associate at least one first quality information with said first timestamp information and receive at least one second quality information related to said second timestamp information.

Advantageously, the addition of quality information makes it possible to indicate the quality of the timestamp information. In some embodiments, this quality information can be information relating to the quality of the first or second reference time information, or even related to the devices that distribute this reference time information. In some embodiments, this quality information can be a precision class of these terminals that distribute reference time information.

According to some embodiments, the device is configured to transmit to a timestamp base at least either or several among:
said first message, said at least one associated timestamp information and said at least one first quality information,
said at least one second timestamp information and said at least one second quality information.

Thus, it is possible to centralize the timestamp information and make it available to several equipment in the second network. It is also possible to archive the timestamp information and the associated quality information for later use, in particular in case of proof for the operator of the second network, in order to prove that it has for example met guarantees in terms of transfer time in its network.

According to some embodiments, the device is configured to transmit to said first client terminal:
said first timestamp information and said at least one associated first quality information,
said second timestamp information and said at least one associated second quality information.

According to this embodiment, it is possible for the client terminal to have access to the timestamp information of the messages it transmits through the second network and to ensure that the communication operator it uses can guarantee a transfer time of the messages in the network while meeting a latency time that suits it.

According to some embodiments, the device is configured to receive said at least one second timestamp information and said at least one associated second quality information either from said at least one second device or from said timestamp base.

According to some embodiments, the device is configured to obtain said first reference time information from the receipt and transmission of one or several messages with a first timestamp server of said second network.

According to some embodiments, said second reference time information is obtained from the receipt and transmission of one or several messages between a second timestamp server and said at least one second device, said first timestamp server and said second timestamp server being synchronized on the same time reference.

This makes it easier to determine the transfer time in the second network when the two reference time information come from the same time reference.

According to some embodiments, the first terminal equipment is a teleaction device for monitoring an electricity network, said first message being a message characterizing said electricity network such as an alert message signaling a fault in said electricity network or a message indicating a normal operation of said electricity network.

In the particular context of the teleaction, the transfer time of the messages in a network is sometimes critical. When the communication networks are wired, it is often possible to guarantee message transfer times so as not to exceed thresholds that would be critical in terms of transfer time. Guaranteeing a transfer time when the networks are cellular can sometimes be more complex and the teleaction services may need a guarantee that the networks used to transfer the teleaction messages can meet this need any time. Thus, the provision of message timestamp information in the network advantageously allows such services or terminals using such services to verify that the transfer times are consistent with those expected.

According to some embodiments, the device is configured to:
receive at least one query for access from said first terminal to the timestamp information relating to at least one of said first messages,
verify the rights of said first terminal to access said timestamp information,
transmit said timestamp information or time information determined from said timestamp information to said first terminal when said first terminal has rights to access said time information.

Advantageously, it may be possible for the timestamp information to be made available for some services only, for example terminals having subscribed to such a service with the communications operator of the second network or terminals of a service provider having subscribed to a teleaction service with the operator. This also makes it possible to limit the number of messages transmitted on the network and therefore the induced load.

According to another aspect, the present invention relates to a communication method implemented in an access gateway, said access gateway comprising:
a first interface with a first network to communicate with a first terminal equipment,
a second interface with a second network different from the first network to communicate with one or several equipment of said second network said method comprising:
updating an internal clock of the access gateway obtained from a first reference time information of one or several equipment of said second network,
receiving at least one first message from said first terminal equipment through said first interface intended to be transmitted to one or several second devices through the second network,
timestamping said at least first message using at least one first timestamp information obtained from said one internal clock, said first timestamp information relating to a date of receipt of said first message in the device, and
transmitting said at least first message through said second interface to said second network,
receiving at least one second timestamp information determined from an internal clock of one of said second devices obtained from a second reference time information, said second timestamp information relating to a date of receipt of said first message in one of said second devices.

According to another aspect, the present invention relates to a computer program comprising instructions for the execution of the steps of the method according to the invention when said program is executed by a computer.

According to another aspect, the present invention relates to a computer-readable recording medium on which is recorded a computer program comprising instructions for the execution of the steps of the method according to the invention.

### BRIEF DESCRIPTION OF THE DRAWINGS

FIG. 1 represents a first example of a network architecture that can implement embodiments of the present invention,

FIG. 2 represents a second example of a network architecture that can implement embodiments of the present invention,

FIG. 3 represents a third example of a network architecture that can implement embodiments of the present invention,

FIG. 4a represents a schematic view of the architecture of FIG. 1 involving a single telecommunications operator,

FIG. 4b represents a schematic view of the architecture of FIG. 1 involving two telecommunications operators,

FIG. 5 represents a first embodiment of the present invention,

FIG. 6 represents a second embodiment of the present invention,

FIG. 7 represents a third embodiment of the present invention,

FIG. 8 represents a fourth embodiment of the present invention,

FIG. 9 represents a fifth embodiment of the present invention.

Other characteristics and advantages of the present invention will emerge from the description given below, with reference to the appended drawings which illustrate one exemplary embodiment thereof without any limitation.

### DESCRIPTION OF THE EMBODIMENTS

The present description refers, for illustrative purposes, to cellular networks and more particularly to networks compliant with the 5G standardized system, but this is only one exemplary embodiment and should not be limited to the use of such networks and associated protocols.

The present invention may find an example in the teleaction or teleprotection applications, but this application is given for illustrative purposes. The teleaction applications are in particular used to control the ingestion of electricity from an energy producer to the distribution network of an energy distributor. The energy distributor continuously supervises the quality of the power line connecting the energy producer. The distributor therefore sends at regular intervals, from a teleaction box, a message with two possible values, one indicating that there is no fault observed on the line and the other indicating that there is a fault observed. The frequency of sending these messages may depend on several factors; typically, it may be 5 ms. When the box of the energy producer receives several consecutive messages indicating that a fault has been observed, the energy producer is disconnected from the electrical distribution network until the electrical fault is observed.

One of the challenges for the telecommunications operators is to guarantee that the exchanged messages are exchanged with a latency below a certain threshold. Indeed, the application to the example of the teleaction given above shows the importance of the time reliability of the information received and of being able to react quickly when faults are observed. The latency time in the network is therefore a data that must be controlled, both for the operator and for the services using the networks of this operator.

It is therefore important, for a telecommunications operator whose network is used for applications requiring controlled transfer times, to be able to guarantee latency in the network and to prove that the network actually meets the expected performance in terms of latency.

One of the objectives of the present disclosure is therefore to allow the telecommunications operator to measure the transfer time in its network from end to end and to be able to provide, to the user services of its network, proof that it has met or not the transfer times it undertakes to guarantee.

FIG. 1 represents a first example of network architecture capable of implementing embodiments of the present invention.

FIG. 1 represents one embodiment based on a 5G cellular telecommunications network but could apply to other communication networks, compatible with other communication architectures, and in particular future 6G architectures and subsequent generations.

FIG. 1 more specifically illustrates the interconnection of two remote terminals, terminal T1 and terminal T2, connected via the network of the telecommunications operator. The two terminals T1 and T2 are for example electronic devices, such as computers, servers or IOT (Internet of Things) modules, or even smartphones.

The terminal T1 is connected to an access gateway P1 provided by the telecommunications operator. This connection can be made for example via a wired or wireless Ethernet network, such as a Wi-Fi network, Bluetooth network or other network. The gateway P1 is an access gateway one of the characteristics of which is the ability to interconnect, on the one hand to the local area network to which the terminal T1 is connected for example via a first network interface, and on the other hand to the network of the telecommunications operator via a second network interface.

Similarly, the terminal T2 is connected to an access gateway P2 provided by the telecommunications operator. This connection can be made for example via a wired or wireless Ethernet network, such as a Wi-Fi network, Bluetooth network or other network. The gateway P2 is an access gateway one of the characteristics of which is the ability to interconnect, on the one hand to the local area network to which the terminal T2 is connected for example via a first network interface, and on the other hand to the network of the telecommunications operator via a second network interface.

The local area networks to which the terminals T1 and T2 are connected may be different from each other.

In the case of the application of the present invention to the teleaction, the terminals T1 and T2 may be teleaction devices.

In the case of FIG. 1 in which the network of the telecommunications operator is a 5G network, the second interface of the gateways P1 and P2 allows them to communicate with each other by the use of this system through the operator network.

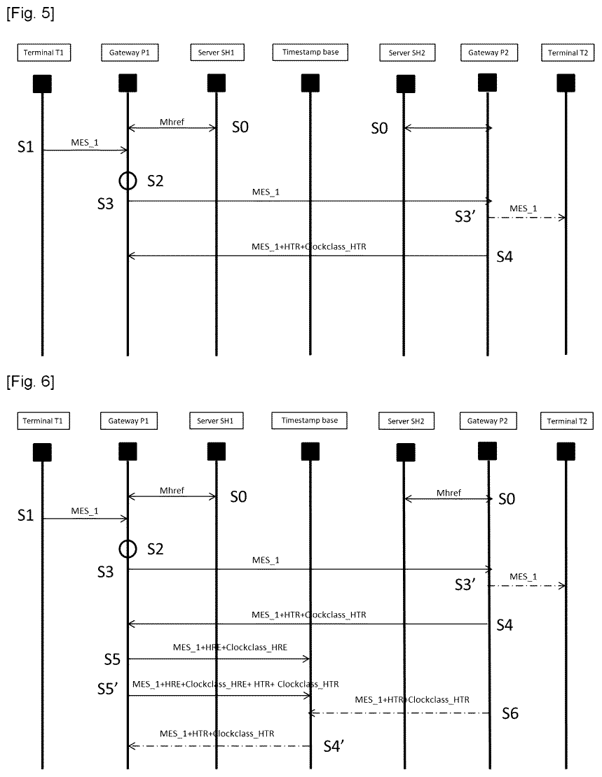

The gateways P1 and P2 are configured to implement a timestamping method as proposed by the present disclosure and as described with reference to FIGS. 5 to 9. As such, the gateways P1 and P2 may be called timestamping gateways.

The network of the telecommunications operator comprises a plurality of network equipment, only some of which are represented in FIG. 1 and FIGS. 2 to 4b.

The network in particular comprises equipment present in the access and transport network part of the operator network. This equipment may include one or several antennas compatible with the communication system used in the network, for example 5G network, as well as one or several timestamp servers SH1, SH2, etc.

The timestamp server(s) SH1, SH2 are configured to communicate with the access gateways P1 and P2. A single server can communicate with both gateways, or two servers can each communicate with one gateway. When two timestamp servers are used, both timestamp servers are synchronized to the same time reference.

The timestamp servers are configured to transmit timestamp information or streams to the gateways P1 and P2, for example by using MIP (Master Information Block) or SIB (System Information Block) messages. The timestamp servers are for example synchronization servers present in the 5G communication networks to which timestamping functionalities are added.

Thus, the timestamping gateways P1 and P2 can be synchronized on the same time scale.

The communication network may also comprise a 5G core network that may comprise a UPF (User Plane Function) server and an information system that may comprise a timestamp base. The timestamp base may advantageously record timestamp information on messages exchanged between the gateways P1 and P2 or between the terminals T1 and T2, in the context of the present disclosure. This information will be described later with reference to FIGS. 5 to 9.

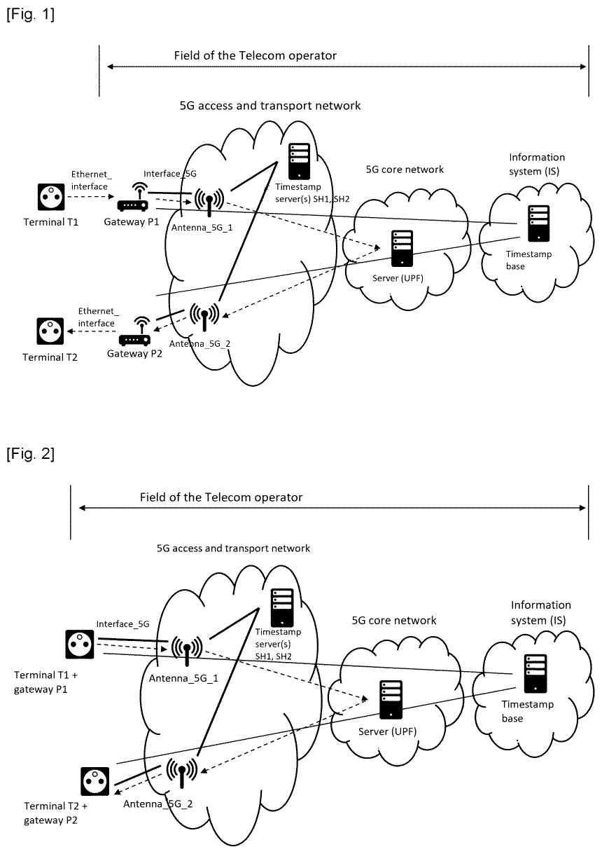

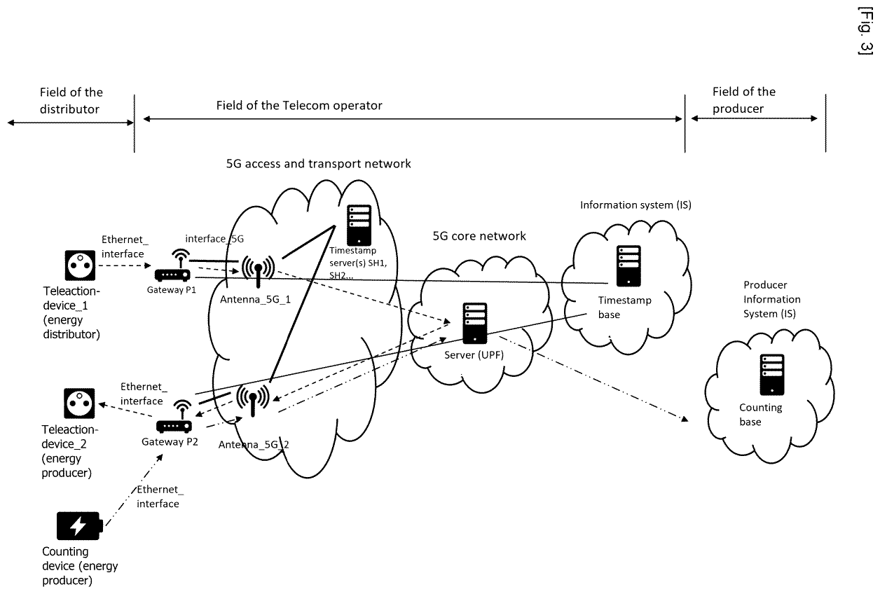

FIG. 2 represents a second example of a network architecture that can implement embodiments of the present invention. In FIG. 2, the terminal T1 and the gateway P1 are a single terminal, as are the terminal T2 and the gateway P2. The other elements of FIG. 2 are identical to those bearing the same references in FIG. 1 and will not be described in more detail here. Of course, in some embodiments, the terminal T1 and the gateway P1 may be combined, while the terminal T2 and the gateway P2 are not combined, or vice versa.

When the terminal T1 and the access gateway P1 form a single device, the terminal T1 is then configured to implement a method as described by the present disclosure, and does not require additional timestamping gateways. In this case, the terminal T1 (or the terminal T2) is configured to timestamp the messages, for example teleaction messages, from information provided by the timestamp server(s).

FIG. 3 represents a third example of network architecture that can implement embodiments of the present invention. In this embodiment, two teleaction devices, teleaction-device_1 and teleaction-device_2, are connected respectively to the gateways P1 and P2. The gateway P1 can for example interface the energy distributor to the communication network and the gateway P2 interfaces the energy producer to the communication network. In addition, a third terminal, counting device, is also located in the domain of the energy producer and connected to the gateway P2. This third terminal can provide counting services for the energy provided by the energy producer to the energy distributor. For this purpose, an information system, connected to the operator network, can comprise a counting base for exchanging data and messages with the counting device of the energy producer. The counting device can also benefit from the timestamping services provided by the timestamp server(s).

In other embodiments, in addition to the counting service, flexibility services, such as clipping applied by the energy distributor to the energy consumer, may be provided.

In other embodiments, the timestamping gateways may be used by other services implemented in the networks connected to the operator network via these gateways. Among these services, the synchronization of robots or industrial processes within factories may be envisaged.

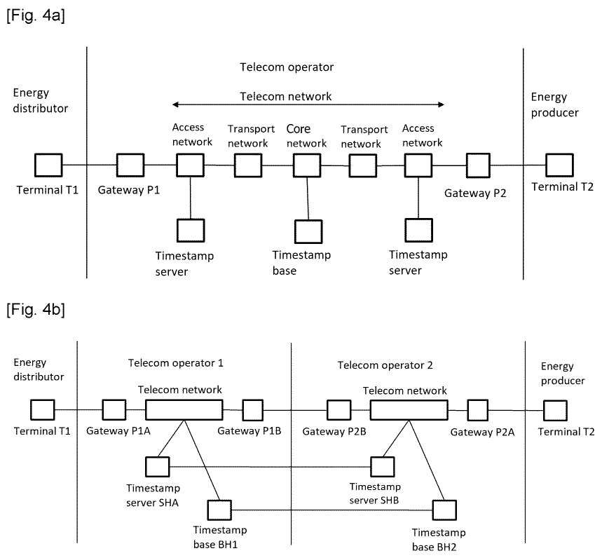

FIGS. 4a and 4b schematically illustrate two embodiments comprising respectively a single telecommunications operator and two telecommunications operators. FIG. 4a corresponds to another representation of the environment described with reference to FIGS. 1 to 3 in which the access gateways P1 and P2 are connected to each other by a single telecommunications operator. FIG. 4b illustrates one embodiment in which the gateways P1 and P2 are replaced respectively by gateways P1A and P2A which are also timestamping gateways like the gateways P1 and P2. The gateway P1A interfaces the terminal T1 to the network of a first telecom operator and the gateway P2A interfaces the network of a second telecom operator to the terminal T2. This embodiment can be implemented when the energy provider and the energy distributor have not subscribed to a subscription with the same telecommunications operator or more generally when the owner of the terminal T1 and the owner of the terminal T2 have not subscribed to a subscription with the same telecommunications operator. The two networks are interconnected with each other via two gateways P1B and P2B connected respectively to the first network and to the second gateway P2B and on the other hand to the second network and to the first gateway P1B. In this embodiment, two timestamp servers SHA and SHB located respectively within the network of the first operator and of the second operator can be synchronized on the same UTC (Universal Time Coordinated) time reference to allow measurement of the transfer time between the gateways P1B and P2B, P1A and P2A or the terminals T1 and T2.

In some embodiments, the two timestamp bases BH1 and BH2 may be shared in the sense that they may each record timestamped data relating to at least each of the two telecommunications operators.

In some embodiments, the two databases are dedicated to each operator in the sense that they only record timestamped data relating to the telecommunications network to which they are connected. The timestamp information relating to the same message may be reconciled using for example a message identifier, for example a message sequence identifier or another message header that can identify it and differentiate it from the other messages, i.e. a unique identifier for the message.

FIG. 5 represents one embodiment of a method according to the present disclosure and which may for example be implemented by either of the examples of architecture given in the preceding figures. The steps of this method are implemented within the gateway P1, but could also be implemented in the same way within the gateway P2.

FIGS. 5 to 9 show two timestamp servers SH1 and SH2. These two timestamp servers are then synchronized to the same UTC time reference.

In other embodiments, the two servers SH1 and SH2 can be replaced by a single timestamp server.

The gateways P1 and P2 exchange messages respectively with the timestamp servers SH1 and SH2. These messages can be exchanged periodically between the gateways and the timestamp servers. By periodically, it is meant on a regular or non-regular basis, at regular or non-regular intervals. The aim here is to guarantee synchronization, and the more regular the messages, the finer the synchronization.

These messages contain reference time information, i.e., a precise indication of time, for example UTC time, allowing the update of the internal clock of the gateway and to the determination of timestamp information HRE for the gateway P1 and HTR for the gateway T2, determined from their internal clock. First reference time information is obtained by the gateway P1 and second reference time information is obtained by the gateway P2.

In some embodiments, this first reference time information and this second reference time information may be identical and may be the UTC time reference. In other embodiments, these two time information are different and synchronized.

According to some embodiments, these messages comprise, in addition to this precise indication of time, quality information associated with this precise indication of time, for example an associated precision class.

In some embodiments, the precision classes may be defined and standardized. This is for example the case of the ITU-T G8275.1 standard used in the telecommunications networks for the needs of 5G, which the equipment according to some embodiments may comply with.

The aforementioned time information can also be transmitted in messages compatible with time-setting protocols, such as for example the PTP (precision time protocol) protocol of the IEEE-1588 standard. Within the framework of the 5G standard, the PTP protocol used is defined by the ITU-T under the reference G.8275.1.

The transmission of time information between the gateways P1, P2 and the timestamp servers SH1 and SH2 is illustrated by a single step S0, which as indicated previously is in reality repeated several times, periodically. In the figures, this is illustrated by the Mhref messages and according to some embodiments, as indicated previously, these messages illustrate the transmission of time information via PTP protocols.

The update of the internal clock of the gateways P1 and P2 from the reference time information obtained respectively from the timestamp servers SH1 and SH2 can also take into account the propagation time between the timestamp servers and the gateways. The propagation time can be calculated by the gateways P1 and P2 from the exchange of bidirectional messages with their respective server SH1 or SH2. For this purpose, the propagation time can be determined by measuring the round-trip transfer time between a gateway and the timestamp server and dividing this time by two, without taking into account the asymmetry that may exist between the forward transfer time and the return transfer time.

This propagation time can for example be added to the reference time information in order to obtain the internal clock of the gateway.

Then, the terminal T1 sends a message MES_1 to one or several equipment on the network, step S1. In the example shown in FIG. 5, the message is intended for the terminal T2. When the method is implemented in an architecture such as the one illustrated in FIG. 2, it is noted that the terminal T1 and gateway P1 are combined, just as the terminal T2 and the gateway P2 may or may not be combined. When the gateway P1 and the terminal T1 are combined, then step S1 does not exist, the message MES_1 is transmitted to the terminal T2 from the gateway P1.

During a step S2, the gateway P1 timestamps the message MES_1 using at least its internal clock, set to the time from at least one first reference time information obtained during step S0. This reference time information can be obtained from one or several equipment of the second network and in particular of the timestamp server SH1.

The timestamping of the message MES_1 comprises the association or the insertion of a timestamp information, HRE, with/into the message MES_1.

In some embodiments, the gateway P1 timestamps the message MES_1 using not only the timestamp information HRE but also using the quality information, for example an associated precision class clockclass_HRE.

Preferably, the timestamp information HRE corresponds to the time of receipt of the message MES_1 in the gateway P1. When the gateway P1 and the terminal T1 are combined, HRE may correspond to the time of transmission of the message MES_1 by the gateway P1 on the communication network.

During step S3, the message MES_1 is transmitted to the gateway P2. The message MES_1 may then be transmitted to the terminal T2 when it is addressed to it (or to several terminals such as the terminal T2 or terminals located behind gateways identical to the gateway P2), step S3′. It may be noted that the message MES_1 transmitted to the gateway P2 or to the terminal T2 is not necessarily transmitted with the first timestamp information before being transmitted. In such an embodiment, steps S3 and S3′ may be performed before step S2.

The gateway P1 receives, in step S4, a second timestamp information, HTR, from the second gateway P2 relating to the message MES_1. The gateway P2 generates the timestamp information HTR using its internal clock, set to the time from the reference time information exchanged via the Mhref type messages.

The internal clocks of the gateway P1 and the gateway P2 are advantageously updated regularly or periodically. As indicated previously, by periodic it is meant on a regular or non-regular basis, at regular or non-regular intervals. The aim here is to guarantee synchronization and the more regular the messages, the finer the synchronization.

The second timestamp information can be received in different formats or in different messages.

In some embodiments, the second timestamp information is associated with the message MES_1 by being inserted into the message MES_1 which is retransmitted to the gateway P1 by the gateway P2.

In some embodiments, the second timestamp information is transmitted to the gateway P1 in another message, different from the message MES_1, into which is also inserted an identifier of the message MES_1 allowing the gateway P1 to associate the second timestamp information received with the message MES_1.

The second timestamp information may also be associated with second quality information, clockclass_HTR, for example a precision class.

Preferably, the timestamp information HTR corresponds to the time of receipt of the message MES_1 in the gateway P2 if the message is intended for the gateway P2 or the time of retransmission of the message MES_1 to the terminal T2 when the message is intended for it and the terminal T2 is separate from the gateway P2.

The gateway P1 has the first timestamp information HRE and the second timestamp information HTR, as well as, when they are transmitted or determined, quality information such as the precision class. The gateway P1 can therefore determine the transfer time of the message MES_1 in the communication network. This determination can for example consist of differentiating between HTR and HRE.

Thus, the gateways P1 and P2 advantageously comprise timestamp functions that can be used by one or several applications that would require them, in particular information relating to transfer times in the network.

FIG. 6 represents a second embodiment in which steps S0, S1, S2, S3, S3′ and S4 are repeated and are not described here.

FIG. 6 illustrates more particularly the use of a timestamp base allowing the recording of the timestamp data, in particular the first and second timestamp data, namely HRE and HTR, but also the associated quality information.

The method comprises the transmission, step S5, of the first timestamp information HRE to the timestamp base. In addition to the first timestamp information, the associated quality information, clockclass_HRE, can also be transmitted to the timestamp base. Step S5 can advantageously be replaced by a step S5′ in which, in addition to the first timestamp information, the second timestamp information can also be transmitted, as well as the first and second quality information, clockclass_HRE and clockclass_HTR. Thus, the timestamp base can associate the at least two timestamp information with the message MES_1 or with an identifier, for example a sequence identifier, relating to the message MES_1. These two information advantageously make it possible to determine and subsequently transmit, thanks to their recording, the transfer time in the communication network.

Step S5 may also be followed, or preceded by a step S6 or simultaneous with a step S6 in which the second timestamp information HTR is transmitted by the gateway P2 to the timestamp base. It may be transmitted with the second quality information, clockclass_HTR.

In the embodiment represented in FIG. 6, step S4 may be replaced by a step S4′, consecutive either to step S5′ or to step S6. In this step S4′, the second timestamp information, HTR, and possibly the second quality information clockclass_HTR, is transmitted to the gateway P1 by the timestamp base.

As indicated previously with reference to step S4, in steps S4′, S5, S5′, S6, the second timestamp information HTR and the first timestamp information HRE (and possibly the associated quality information clockclass_HRE and clockclass_HTR) can be transmitted to the gateway P1 or to the timestamp base, in another message different from the message MES_1 into which is also inserted an identifier of the message MES_1 allowing the gateway P1 to associate with the message MES_1 the second timestamp information received.

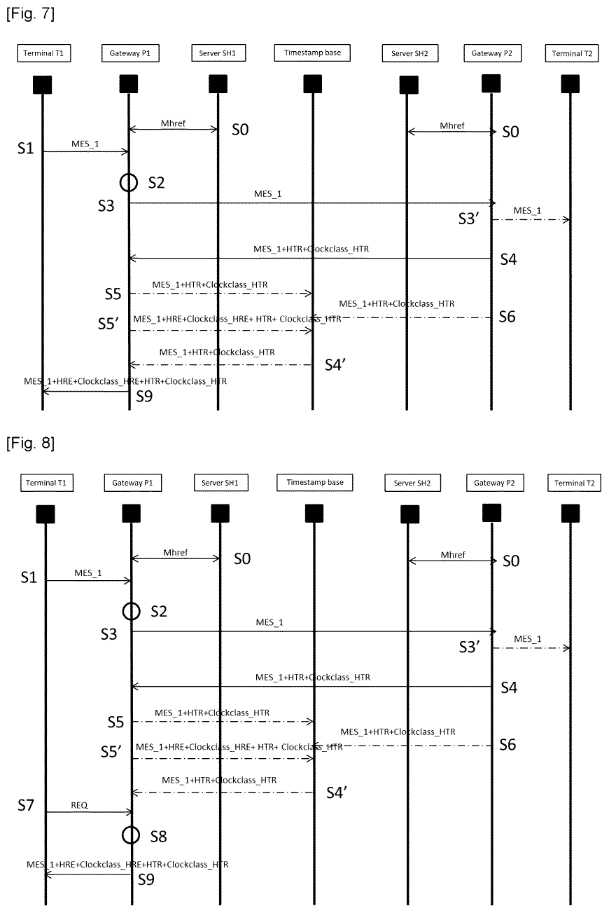

FIG. 7 represents another embodiment in which the gateway P1 transmits the timestamp information to the terminal T1, step S9. This step S9 advantageously allows the terminal T1 to have information relating to the transfer time of the packets in the communication network it uses. The terminal T1 can thus ensure that the transfer conditions guaranteed by the communication network comply with requirements it would have for the communication network. Similarly, this can advantageously allow the communication network to provide the information relating to the packet transfer time in the network.

According to some embodiments, the information transmitted during step S9 is time information determined from the timestamp information. Thus, the gateway P1 can determine, for each or some of the messages MES_1, its transfer time in the network, and transfer this information during step S9 to the terminal T1. This information can be transmitted in the retransmitted message MES_1 or in other messages, the determined time information being able to be associated with an identifier of the message so that it can be associated with the message MES_1 by the terminal T1.

FIG. 8 represents another embodiment in which the client terminal T1 requests from the gateway P1, step S7, the timestamp information associated with one or several messages MES_1. This embodiment differs from that of FIG. 7 in that the gateway P1 transmits the time information relating to the messages transmitted by the terminal T1 to the terminal T2 only upon request from the terminal T1.

In some embodiments, during a step S8, the timestamping gateway P1 can verify the access rights of the terminal T1 from an identifier of the terminal T1, identifiers of the messages concerned and any security information associated with the communication network.

In some embodiments, this verification of the access rights can consist of a verification that the terminal T1 is subscribed to a teleaction service and that, as a result, it can verify the transfer times of the teleaction messages in the communication network.

In some embodiments, this verification of the access rights may be the verification that the query made by the terminal T1 complies with a subscribed request frequency for the service. If this is not the case, the query is rejected.

When the verification of the access rights indicates that the terminal T1 has the right to access the requested timestamp information, the gateway P1 transfers the timestamp information or information relating to this timestamp information (for example the transfer time calculated by the gateway) to the terminal T1, step S9. FIG. 8 indicates the transmission of a message MES_1 as well as timestamp information HRE, HTR, Clockclass_HRE and Clockclass_HTR. However, as mentioned previously, the transmission of the timestamp information and associated quality information may be executed in a message different from the message MES_1, by being associated with an identifier of the message MES_1 so that the terminal T1 can associate the received timestamp information with the message MES_1.

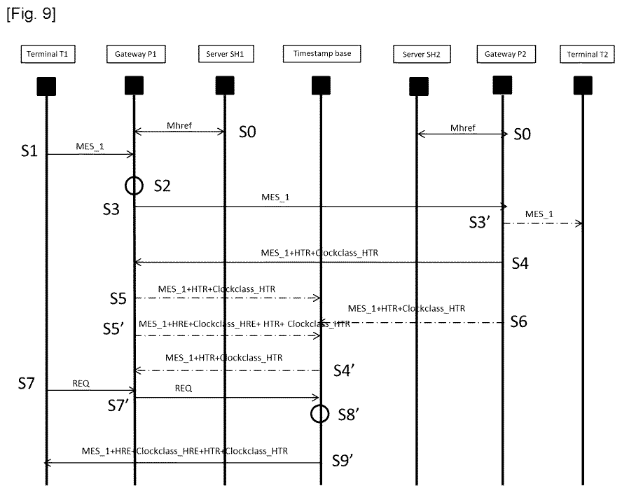

FIG. 9 represents another embodiment in which, following step S7, the request from the client terminal is transmitted to the timestamp base, step S7′. This can be particularly advantageous to prevent the gateway P1 from keeping all the timestamp information, the timestamp base having sufficient capacities to record it and distribute it to one or several client terminals. This step can also be implemented when the query issued by the terminal T1 relates to old messages for which the gateway P1 has not kept the associated timestamp information. The control of the rights to access the timestamp information can be performed by the timestamp base, step S8′, which replaces step S8 of the embodiment of FIG. 8. When the verification of the access rights indicates that the terminal T1 has the right to access the requested timestamp information, the timestamp base transfers the timestamp information to the terminal T1, step S9′. As in step S9 described previously, the information transmitted during step S9′ is time information determined from the timestamp information. Thus, the gateway P1 can determine, for each or some of the messages MES_1, its transfer time in the network, and transfer this information during step S9 to the terminal T1. This information can be transmitted in the retransmitted message MES_1 or in other messages, the determined time information being able to be associated with an identifier of the message so that it can be associated with the message MES_1 by the terminal T1.

As indicated previously, in the embodiments and FIGS. 1 to 9, the terminal T1 can be a teleaction device present at an energy distributor, the terminal T2 being a teleaction terminal present at the energy provider. The messages MES_1 can be teleaction messages, that is to say messages that characterize the electricity network such as an alert message signaling a fault in or a message indicating a normal operation of the electricity network.

The teleaction messages are particularly important and therefore require reliability in their routing. One of the challenges for the telecommunications network is to be able to guarantee the requested transfer time. Thus, as described previously, with reference to FIGS. 8 and 9, a teleaction terminal T1 can transmit a query to the gateway P1 in order to obtain information relating to the transfer time of the teleaction messages in the network.

On the one hand, the network can monitor the transfer time of a message in the network and observe the evolution of this transfer time over time. This can advantageously allow the network to detect an anomaly in the network, a congestion problem, a network equipment problem.

On the other hand, the network operator can prove if necessary, to a user of the network, that it has guaranteed a transfer time of the messages compliant with its commitment when it undertakes to transmit packets with a guaranteed maximum latency.

In the embodiments presented above, the quality parameters used may depend on protocols used in the communication network. The IEEE1588-2019 and ITU-T-G.8275 standards may for example propose the following quality parameter for the parameter clockclass_HRE ou clockclass_HTR:

| Value | description |
|---|---|
| 6 | normal operation, good synchronization |
| | of the timestamp server. |
| 7 | degraded but acceptable operation of the |
| | timestamp server. |
| 135-165 | clock accuracy not guaranteed. |
| 140-150-160 | Timestamp server accuracy considered |
| | poor |

In some embodiments, the quality information, such as the clockClass, is transmitted in each “Announce” message as determined by the PTP protocol and is transmitted by master ports of the network.

In some embodiments, the present disclosure therefore relates to a communication device, for example a modem or an access gateway between a first network, a local area network and a second network, a cellular network, comprising:
a first interface with the local area network to communicate with a first terminal equipment, the terminal equipment being able to implement at least one service, for example a teleaction service for monitoring an electricity network,
a second interface with the second network to communicate with one or several equipment of the second network,
one or several processors configured together or separately to:
update an internal time clock obtained from a first reference time information of one or several equipment of said second network, the update being able to be performed regularly over time,
receive at least one first message from said first terminal equipment through said first interface intended to be transmitted to one or several second devices through the second network,
timestamp said at least first message using a first timestamp information determined from said internal time clock,
transmit said at least first message through said second interface to the second network,
receive at least one second timestamp information determined from a second internal clock of one of said second devices, said second timestamp information relating to a date of receipt of said first message in one of said second devices, and said second internal clock being updated from a second reference time information obtained from one or several equipment of said second network,
determine at least one transfer time of the first message in the second network,
transmit to the first terminal at least one information relating to the transfer time, the transmission possibly following a request query for this information by a service present in the first terminal.

The service present in the first terminal is for example an electricity network management service.

As mentioned previously, the terminal T1 can implement the teleaction service and, as such, subscribe from the telecommunications operator to a service for transporting the teleaction messages through the communications network of the operator. The terminal T1 requests the guarantee that the teleaction messages are transmitted while meeting a certain maximum latency time in the network and can request verification that the network can guarantee this latency time for the transmitted teleaction messages.

The access gateway can provide a timestamping service for the messages exchanged between the two terminals T1 and T2 managing an electricity network. The exchanged teleaction messages, for which the transfer time is to be particularly monitored, inform the remote terminal that there is for example a fault at the energy producer.

The present disclosure allows the verification of this latency time by the terminal T1 following the sending of timestamp information or information relating to this timestamp or transfer time information obtained from this timestamp information, by the gateway P1. It also allows the telecommunications operator to provide proof that it is indeed meeting this latency time for each or several teleaction messages.

Thus, following steps S9 or S9′, the terminal T1 can compare the time information transmitted by the gateway P1 with maximum latency information (or an acceptable range of transfer time values) that it wishes for the transport of the messages in the network, and signal to the network operator by sending a message through the gateway P1, that this transfer time is not met. This maximum latency information in the network represents the maximum switching time of a teleaction packet in the network to guarantee an operation of the teleaction service.

In some embodiments, it is not the terminal T1 but the gateway P1 that verifies that the effective switching time of a teleaction packet in the network is less than or equal to the switching time guaranteeing the operation of the teleaction service.

The verification consists in comparing for one or several messages MES_1, the actual time, obtained for example by taking the difference between HTR and HRE, and the time determined by the teleaction service to guarantee the operation of the teleaction service.

Following the verification, a message may be transmitted to the telecommunications network operator, and to the teleaction service, or to the energy distributor. When the verification determines that the actual time does not guarantee the operation of the teleaction service, an alarm may be generated to the first terminal and/or to the network operator and the network operator may intervene on one or several network equipment to guarantee the operation of this service again. The alarm transmitted to the telecommunications network operator may trigger a notification to the supervision system of this operator to initiate the necessary investigations and thus return to normal operation.

The alarm transmitted to the energy distributor may trigger a backup mode for the terminal T1. There is also a notification, via this terminal T1, to the supervision system of the energy distributor to possibly modify the distribution policy for the geographical area concerned during this abnormal operation.

The access gateways P1 and P2 can support messages compliant with the PTP protocol to update their internal clock from the time information transmitted by the timestamp server(s). The gateways P1 and P2 can also transmit messages compliant with the “GOOSE” (Generic Object-Oriented Substation Events) protocol according to the international standard IEC 61850.

The messages MES_1 described above can therefore be GOOSE messages transmitted between the terminal T1 and the gateway P1 over an Ethernet network and then transmitted, in an encapsulated manner, over a cellular communication network, for example 5G. The GOOSE messages can for example be transmitted using the UDP protocol in the 5G network.

Thus, advantageously, the teleaction messages usually exchanged on Ethernet networks can be encapsulated in UDP messages on the communication network between the two gateways P1 and P2. The present disclosure makes it possible to control the transfer time of these messages in the communication network, and to provide the information to the terminal T1 whether this transfer time is met or not if the operator of the telecommunications network has made commitments relating to this transfer time.

Of course, the method described also applies to services other than the teleaction services, such as the industry of the future, mobility services, supply chains. In particular, the implementation of a timestamp function in the network interface advantageously makes it possible to interconnect several areas of responsibility. The example given in FIG. 4b showing the interconnection of several networks is generalizable to a plurality of players. Concretely, in the field of industry and supply chains, it can be a timestamp mechanism for the entire transformation chain of a manufactured product. This product may therefore have to transit between networks of different types, such as outdoor cellular networks for pre-assembly, then a private cellular network inside the factory walls for machining, then a shipment for delivery outside the factory.

1. A communication device comprising:
a first interface with a first network to communicate with a first terminal equipment,
a second interface with a second network different from the first network to communicate with at least one equipment of said second network, and
one or more processors configured together or separately to:
update an internal clock of the device from a first reference time information obtained from said at least one equipment of said second network,
receive at least one first message from said first terminal equipment through said first interface intended to be transmitted to one or more second devices through the second network,
timestamp said at least first message using at least one first timestamp information obtained from said one internal clock, said first timestamp information relating to a date of receipt of said first message in the device, and
transmit said at least first message through said second interface to said second network, and
receive at least one second timestamp information determined from an internal clock of one of said one or more second devices obtained from a second reference time information, said second timestamp information relating to a date of receipt of said first message in one of said one or more second devices.

2. The device of claim 1 further configured to determine a transfer time in said second network from said first timestamp information and said second timestamp information.

3. The device of claim 1, further configured to:
associate at least one first quality information with said first timestamp information and,
receive at least one second quality information related to said second timestamp information.

4. The device of claim 3 further configured to transmit to a timestamp base at least either or several among:
said first message, said at least one associated timestamp information and said at least one first quality information, and
said at least one second timestamp information and said at least one second quality information.

5. The device of claim 1, further configured to transmit to said first client terminal:
said first timestamp information and said at least one associated first quality information, and
said second timestamp information and said at least one associated second quality information.

6. The device of claim 1, further configured to receive said at least one second timestamp information (HTR) and said at least one associated second quality information (clockclass_HTR) either from said at least one second device (P2) or from said timestamp base.

7. The device of claim 1, further configured to obtain said first reference time information from the receipt and transmission of one or more messages with a first timestamp server of said second network.

8. The device of claim 1, wherein said second reference time information is obtained from the receipt and transmission of one or several messages between a second timestamp server and said at least one second device, said first timestamp server and said second timestamp server being synchronized on a same time reference.

9. The device of claim 1, wherein the first terminal equipment is a teleaction device for monitoring an electricity network, said first message being a message characterizing an operational state of said electricity network.

10. The device of claim 9, further configured to:
receive at least one query for access from said first terminal to the timestamp information relating to at least one of said first messages,
verify rights of said first terminal to access said timestamp information, and
transmit said timestamp information or time information determined from said timestamp information to said first terminal in response to a determination that said first terminal has rights to access said time information.

11. A communication method implemented in an access gateway, said access gateway comprising:
a first interface with a first network to communicate with a first terminal equipment, and
a second interface with a second network different from the first network to communicate with at least one equipment of said second network, said method comprising:
updating an internal clock of the access gateway from a first reference time information obtained from at least one equipment of said second network,
receiving at least one first message from said first terminal equipment through said first interface intended to be transmitted to one or more second devices through the second network,
timestamping said at least first message using at least one first timestamp information obtained from said one internal clock, said first timestamp information relating to a date of receipt of said first message in the device, and
transmitting said at least first message through said second interface to said second network,
receiving at least one second timestamp information determined from an internal clock of one of said one or more second devices obtained from a second reference time information, said second timestamp information relating to a date of receipt of said first message in one of said one or more second devices.

12. (canceled)

13. A non-transitory computer-readable recording medium instructions which, when executed by a processor, cause the processor to implement the steps of the method of claim 11.
